(19) United States
(12) Patent Application Publication
(10) Pub. No.: US 2009/0119927 A1
(43) Pub. Date: May 14, 2009

(54) Foldable saw with folding in guide

(76) Inventor: Teng-Lung Chen, Taichung (TW)

Correspondence Address: Teng-Lung Chen, P.O. Box 2103, Taichung, 403, TW

(21) Appl. No.: 11/979,975

(22) Filed: Nov. 13, 2007

(51) Int. Cl. B23D 51/01; B27B 21/00

(52) U.S. Cl. 30/161

(57) ABSTRACT

A foldable saw provided with a fold in guide structure to solve problems of a handle being damaged by teeth of a blade upon folding in the blade to the handle and frustrated folding in process found with the prior art due to that those teeth of the blade are frequently stuck by the handle of a foldable saw of the prior art upon folding in the blade for storage; multiple guide structures are respectively provided on both sidewalls facing each other in an accommodation channel of a handle to receive the blade; the blade when folding into the accommodation channel is led by those guide structures to enter into a track of the accommodation channel without deflection.

### BACKGROUND OF THE INVENTION

(a) Field of the Invention

The present invention is related to a foldable saw provided with a folding in guide, and more particularly, to a foldable saw provided with a guide structure in an accommodation channel in a handle of the foldable saw to facilitate smooth folding in the blade into the accommodation channel.

(b) Description of the Prior Art

Referring to FIGS. 8 and 9 of the accompanying drawings, a foldable saw of the prior art has a blade 41 and a handle 42 pivoted to each other with the blade 41 may be rotated and folded in an accommodation channel disposed in the handle 42.

However, some problems observed with the foldable saw of the prior art may trouble its user. For example, when the blade is rotated and folded in, teeth of the blade often fail to align at the accommodation channel. Accordingly frequent friction and holding against each are frequently seen at where between those teeth of the blade and the handle structure at where the accommodation channel is disposed, e.g., a terminal of the handle to result in frustrated work and damaged structure of the handle at where the accommodation channel is provided.

Furthermore, upon sawing a work piece, a user usually tends to sweat or a user who suffers hyperhidrosis palmaris (excessive sweating on both hands), the sweats could land on the handle or hand sweats may cause it difficult to hold firm the foldable saw that warrants further improvement of the structure of a foldable saw.

### SUMMARY OF THE INVENTION

The primary purpose of the present invention is to provide a foldable saw provided with a fold in guide to solve those problems observed with the prior art by having multiple guide structures disposed in an accommodation channel of the handle to facilitate folding in a blade without causing the blade to get stuck or the handle to be damaged.

Another purpose of the present invention is to provide a foldable saw that has its handle covered up with a slip-proof structure to help secure a firm grip of the handle without being slipping due to presence of sweats.

To achieve these purposes, a foldable saw of the present invention is comprised of a handle and a blade. The handle is essentially comprised of a first shaft and a second shaft combined to each other; and an accommodation channel is disposed at where between both of the first and the second shafts are facing each other. The accommodation channel is located in a longitudinal direction of a body of the handle and multiple guide structures are respectively provided on both inner sidewalls facing each other in the accommodation channel. Each guide structure is provided with an arc section and an extended section; the extended section externally extends from a bottom of the accommodation channel along its sidewall, and the arc section is formed at where closer to an opening of the accommodation channel and externally reduced. Those guide structures disposed on both inner sidewalls facing each other in the accommodation channel are provided by a pair facing each other; and a gap is defined between each pair of guide structures facing each other. The gap is getting wider from the extended section up to the arc section.

The blade has its heel pivoted to a front of the handle and is folded into the accommodation channel as led by the arc section and the extended section of the guide structure; wherein the blade guided is folded in toward the gap.

### BRIEF DESCRIPTION OF THE DRAWINGS

FIG. 1 is a perspective view of the present invention.

FIG. 2 is an exploded view of a handle of a foldable saw partially taken from FIG. 1 for observation of an arc section and an extended section of a guide structure in the present invention.

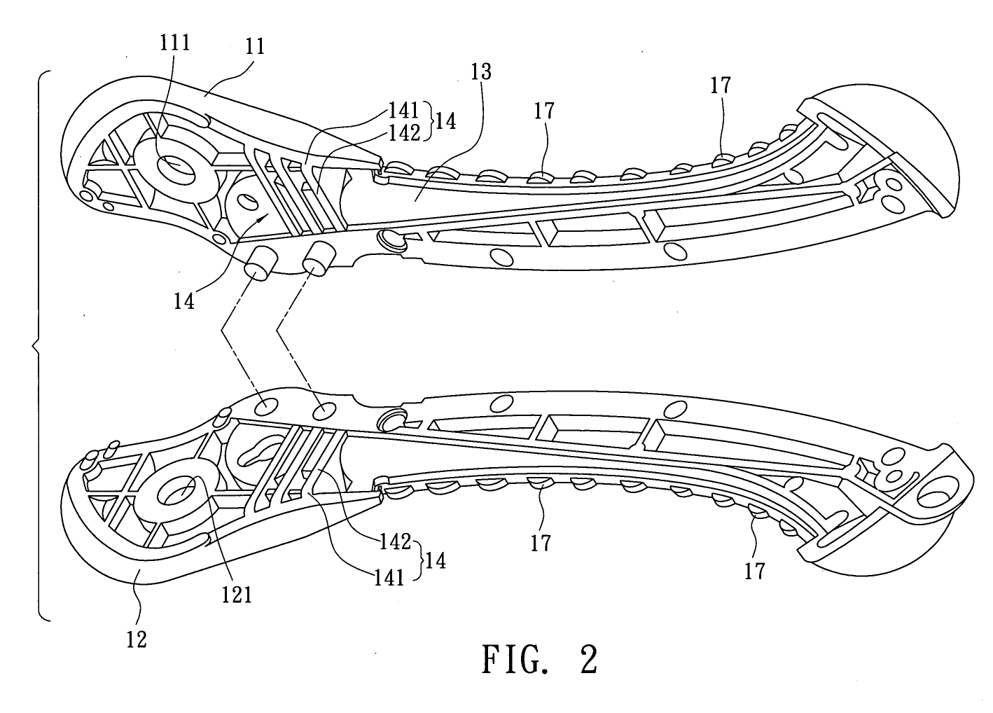

FIG. 3 is another schematic view angling at another angle on a foldable saw taken from FIG. 1 for observation of an accommodation channel and the guide structure of the present invention.

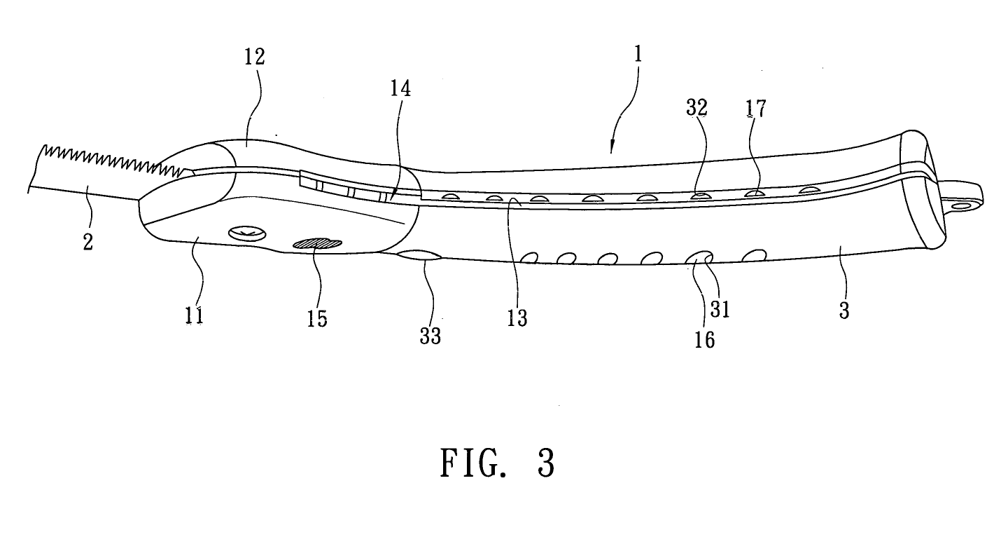

FIG. 4 is a layout showing the foldable saw taken from FIG. 3 for observation of a gap in the accommodation channel of the foldable saw of the present invention.

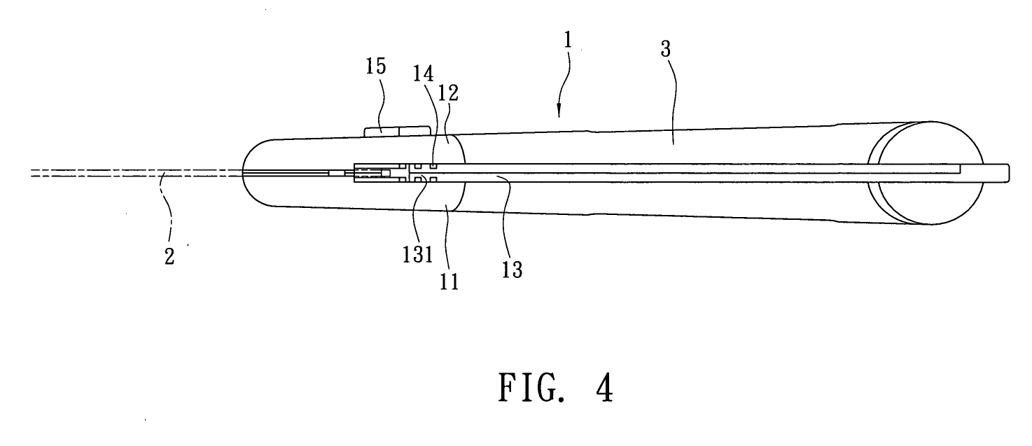

FIG. 5 is a view of cross section of the preferred embodiment of the present invention when a first shaft and a section shaft are separated from each other and a slip-proof structure is assembled to a handle of the present invention.

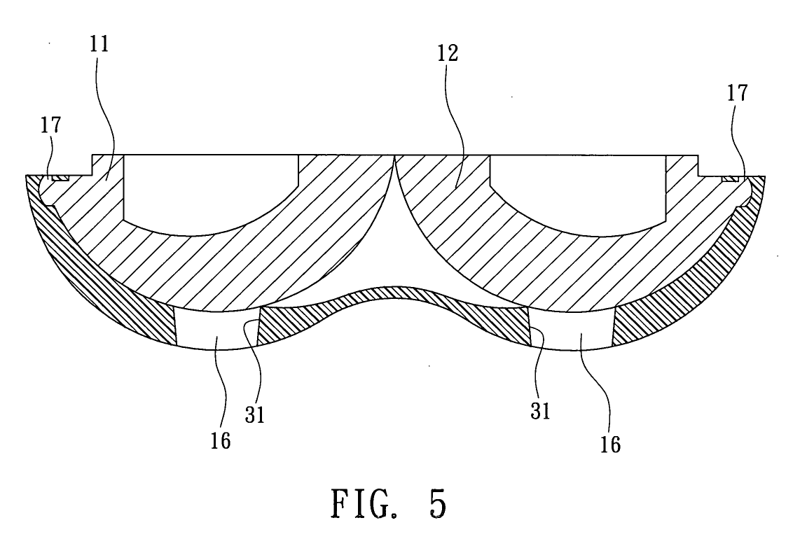

FIG. 6 is a perspective view showing that a blade of the foldable saw of the present invention is smoothly folded in the accommodation channel of the handle.

FIG. 7 is a schematic view showing a guide structure is disposed in the accommodation channel at the preferred embodiment of the present invention.

FIG. 8 is a schematic view showing that a foldable saw of the prior art is in its stretched status.

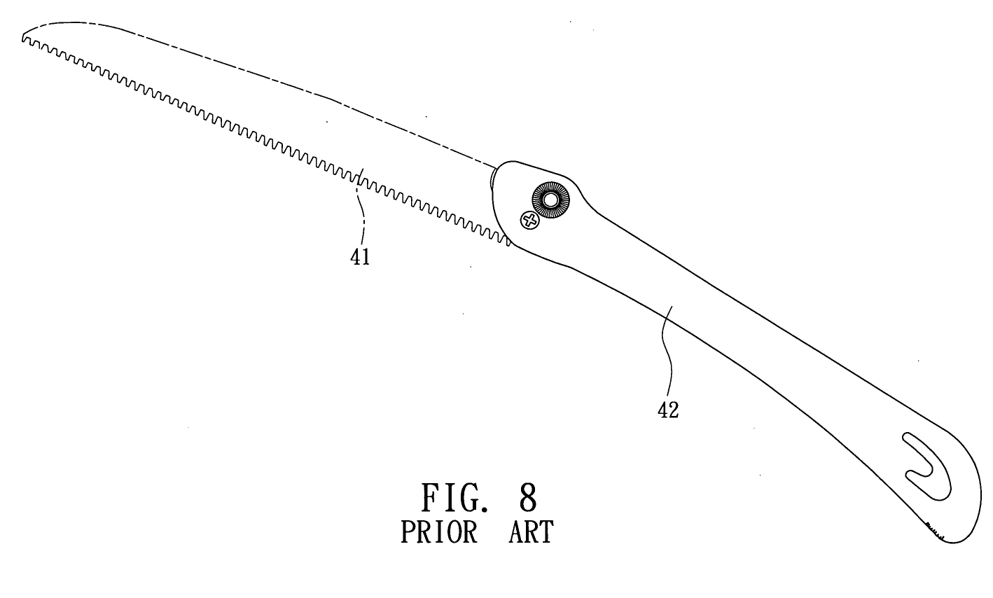

FIG. 9 is another schematic view showing that the foldable saw of the prior art is in its folded in status with a shadowed are showing friction and jamming taking place between the blade and the handle.

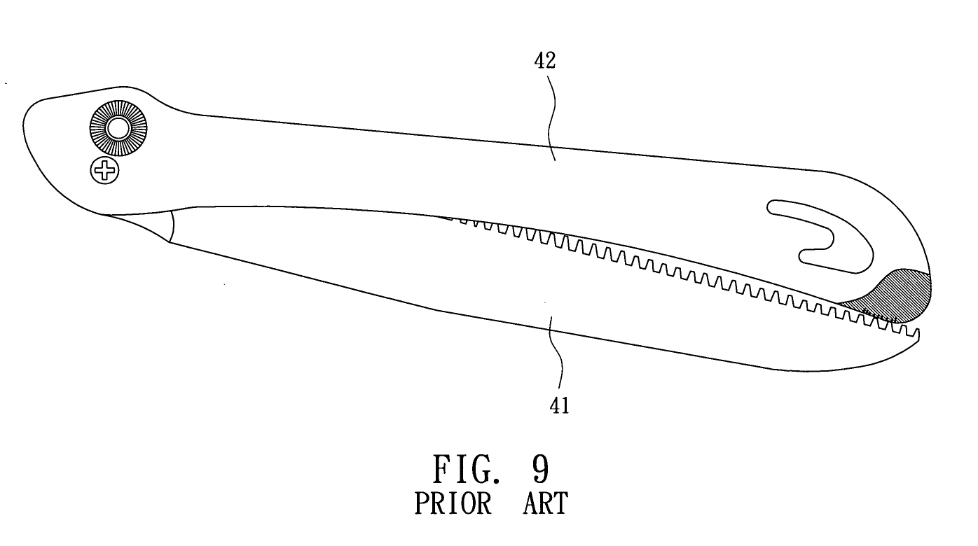

### DETAILED DESCRIPTION OF THE PREFERRED EMBODIMENTS

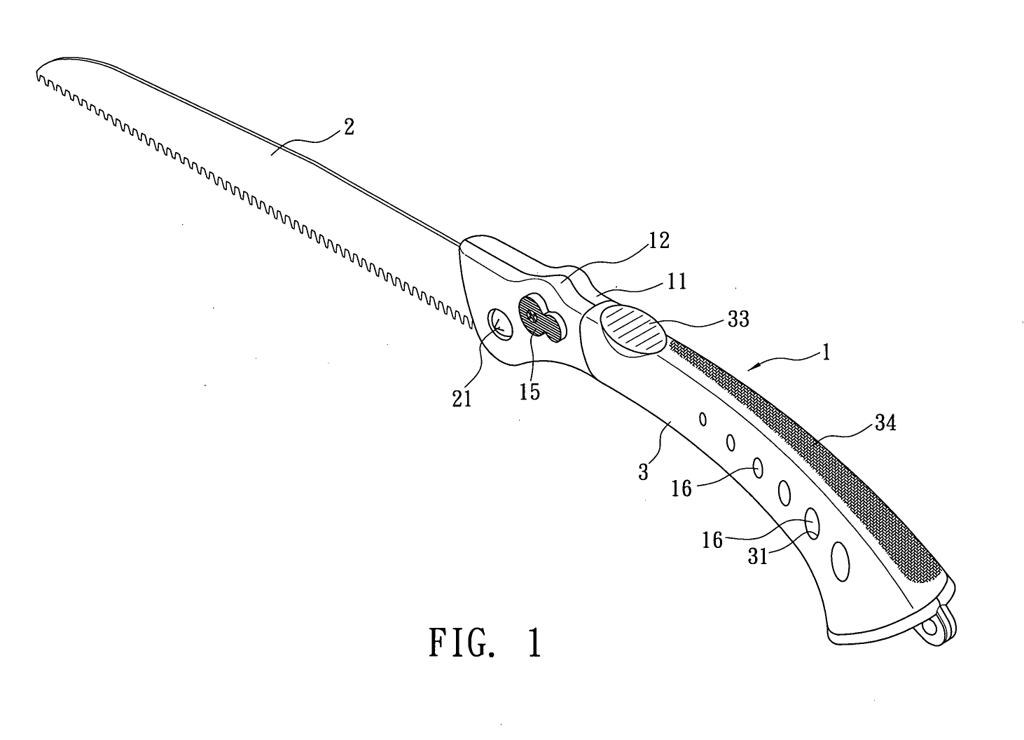

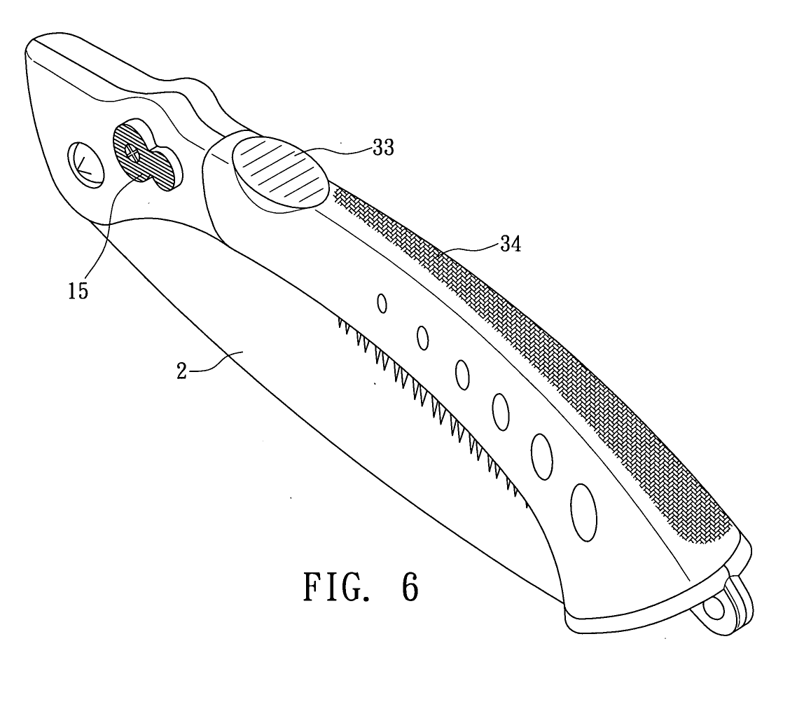

Referring to FIGS. 1 and 6 for a preferred embodiment of the present invention, a foldable saw provided with a fold in guide structure is essentially comprised of a handle 1, a blade 2, and a slip-proof structure 3. The handle 1 is comprised of a first shaft 11 and a second shaft 12 closing upon each other; an accommodation channel 13 is defined at where both of the first shaft 11 and the second shaft 12 are facing each other; the accommodation channel 13 is disposed in a longitudinal direction along a body of the handle 1; multiple guide structures 14 are respectively disposed on both inner sidewalls facing each other in the accommodation channel 13 with each guide structure 14 containing an arc section 141 and an extended section 142; the extended section 142 externally extends from a bottom of the accommodation channel 13 running along the sidewall of the accommodation channel 13 and externally reducing at where close to an opening of the accommodation channel 13 to form the arc section 141; those guide structures 14 disposed on both inner sidewalls facing each other in the accommodation channel 13 are provided by pair; a gap 131 is defined between two guide structures facing each other; the gap 131 is getting wider from the extended section 142 up to the arc section 141.

The blade 2 has one end pivoted to a front of the handle 1 by means of a screw 21 and a nut; the screw 21 passes through a through hole 121 disposed on the second shaft 12 and another through hole 111 disposed on the first shaft 11 before being fastened by the nut; a control member 15 to control locating the blade 2 in its stretched or folded in status is disposed at the front of the handle 1; the control member 15 exercises its function by being pressed; the blade 2 is guided by the arc section 141 and the extended section 142 of the guide structure 14 to be folded in the accommodation channel 13; and a portion of the blade 2 that is guided is folded in facing the gap 131.

In the preferred embodiment, each guide structure 14 is disposed in the accommodation channel 13 at where close to the blade 2 and the handle 1 are pivoted to each other.

The slip-proof structure 3 is disposed on the outer side of the handle 1 and covers up exteriors of both of the first shaft 11 and the second shaft from the inner sidewalls of the opening of the accommodation channel 13; wherein relatively outer sides of the first shaft 11 and the second shaft 12 are respectively disposed with multiple first raised portions 16 in different sizes from one another; and a first opening 31 is disposed to each first raised portion 16. Each first opening 31 is locked in by the raised portion 16 so to secure the slip-proof structure 3. Multiple second raised portions 17 are respectively disposed on both inner sidewalls at where close to the opening of the accommodation channel 13 and the slip-proof structure 3 is provided with multiple second openings 32 at where close to sidewalls of the opening of the accommodation channel 13. Each second opening 32 is locked in by its corresponding second raised portion 17 so to secure the slip-proof structure 3 in place. A thumb rest 33 is provided for the slip-proof structure 3 at where close to the handle 1 and the blade are pivoted to each other; and a slip-proof pattern 34 is dispose for the at slip-proof structure 3 where between the thumb rest 33 and a rear end of the handle 1.

To fold in the blade 2, the blade 2 is turned and a portion of the blade 2 close to where the blade 2 is pivoted to the handle 1 first enters into the opening of the accommodation channel 13 close to where the blade 2 is pivoted to the handle 1; the blade 2 is consecutively led by the arc section 141 and the extended section 142 of the guide structure 14; the arc section 141 is designed to allow direction guide for the blade 2 upon first entering into the accommodation channel 13 and the extended section provides the subsequent guide to the blade 2. Meanwhile, a side of the blade 2 is held against and received by the extended section 142 to limit a location of the blade 2 so to complete the guide of folding in the blade 2.

Accordingly, the present invention by providing a guide structure corrects the problem of damaging the blade when folded into the handle; and the design of a slip-proof structure helps a firm grip of the handle for a user working with the foldable saw.

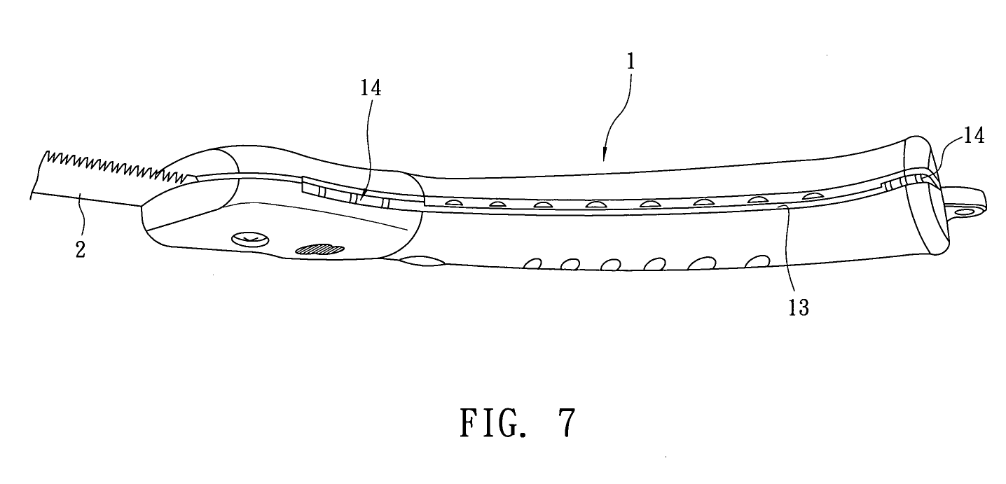

Of course there are many preferred embodiments of the present invention by having changes in details. As illustrated in FIG. 7, a second preferred embodiment is provided with multiple guide structures 14 in the accommodation channel 13 at where close to the rear end of the handle 1. Accordingly, more guide structure to be disposed in the accommodation channel would upgrade the leading effects for the blade to be folded in for storage.

I claim:

1. A foldable saw provided with guide structure comprising:
a handle combined with a first shaft and a second shaft, an accommodation channel being defined between the first shaft and the second shaft facing each other, the accommodation channel being located in a longitudinal direction of a body of the handle, both sidewalls facing each other in the accommodation channel being respectively provided with multiple guide structure, each guide structure containing an arc section and an extended section, the extended section externally extending from a bottom of the accommodation channel and along sidewalls in the accommodation channel and to gradually reduce to form the arc section at where close to an opening of the accommodation channel, multiple guide structure disposed on both sidewalls facing each other in the accommodation channel being provided by pair, a gap being defined between two guide structures facing each other; and the gap getting wider from the extended section to the arc section; and
a blade having one end pivoted to a front of the handle, the blade being folded into the accommodation channel as led by the arc section and the extended section of the guide structure, and a portion of the blade led by the guide structure being folded in toward the gap.

2. The foldable saw provided with guide structure as claimed in claim 1, wherein those guide structures are disposed in the accommodation channel close to where the blade is pivoted to the handle.

3. The foldable saw provided with guide structure as claimed in claim 2, wherein multiple guide structures are further disposed in the accommodation channel closer to a rear end of the handle.

4. The foldable saw provided with guide structure as claimed in claim 1, wherein a slip-proof structure is externally disposed to the handle; and the slip-proof structure covers up the first shaft and the second shaft from the inner sidewalls in an opening of the accommodation channel.

5. The foldable saw provided with guide structure as claimed in claim 4, wherein multiple first raised portions are respectively disposed on outer sides of the first and the second shafts; a first opening is disposed to each first raised portion for the slip-proof structure; and the first opening is locked in by the first raised portion to secure the slip-proof structure in position.

6. The foldable saw provided with guide structure as claimed in claim 4, wherein multiple second raised portions are disposed on inner sidewalls close to the opening of the accommodation channel; multiple second openings are disposed for the slip-proof structure at where close to inner sidewalls of the opening of the accommodation channel; each second opening is locked in by its corresponding second raise portion to secure the slip-proof structure in position.

7. The foldable saw provided with guide structure as claimed in claim 4, wherein a rest is disposed for the slip-proof structure close to where the handle and the blade are pivoted to each other; and a slip-proof pattern is disposed to the slip-proof structure at where between the rest and a rear end of the handle.

8. The foldable saw provided with guide structure as claimed in claim 1, wherein a control member to control locating the blade is disposed at the front of the handle.
